(19) United States
(12) Patent Application Publication
(10) Pub. No.: US 2025/0266432 A1
(43) Pub. Date: Aug. 21, 2025

(54) NEGATIVE ELECTRODE, RECHARGEABLE BATTERY, AND METHOD OF MANUFACTURING NEGATIVE ELECTRODE

(71) Applicant: SAMSUNG SDI CO., LTD., Yongin-si (KR)

(72) Inventors: Bumrae KIM, Yongin-si (KR); Dahyun KIM, Yongin-si (KR); Byonggon LEE, Yongin-si (KR); Haram YEO, Yongin-si (KR); Inhyun HWANG, Yongin-si (KR)

(21) Appl. No.: 19/004,841

(22) Filed: Dec. 30, 2024

(30) Foreign Application Priority Data
Feb. 15, 2024 (KR) 10-2024-0022096

(51) Int. Cl. H01M 4/36; H01M 4/02; H01M 4/04; H01M 10/0587; H01M 50/15

(52) U.S. Cl. CPC H01M 4/366; H01M 4/0402; H01M 10/0587; H01M 50/15; H01M 2004/027

(57) ABSTRACT

A negative electrode of a rechargeable battery includes a substrate, a front active material layer including a first lower layer formed a first surface of the substrate and a first upper layer formed on the first lower layer, and a rear active material layer including a second lower layer formed on a second surface of the substrate and a second upper layer formed on the second lower layer. The edges of the first lower layer and the second lower layer decrease in thickness toward ends of the first and second lower layers to thereby form a first inclined surface and a second inclined surface. The thickness of the end of the first lower layer is more than twice a thickness of the end of the second lower layer.

### CROSS-REFERENCE TO RELATED APPLICATION

This application claims priority to and the benefit of Korean Patent Application No. 10-2024-0022096 filed at the Korean Intellectual Property Office on Feb. 15, 2024, the entire contents of which are incorporated herein by reference.

### BACKGROUND OF THE DISCLOSURE

### (a) Field of the Disclosure

The present disclosure relates to a negative electrode for a rechargeable battery, a rechargeable battery, and a method of manufacturing a negative electrode.

### (b) Description of the Related Art

A rechargeable battery is a battery that is repeatedly charged and discharged, unlike a primary battery. Small rechargeable batteries are used for small portable electronic devices such as mobile phones, laptop computers, or camcorders. Large-capacity and high-density rechargeable batteries are used to store motor driving power or energy for hybrid vehicles and electric vehicles.

These rechargeable batteries are manufactured with an electrode assembly sealed in a case along with an electrolyte, with the electrode assembly having a structure in which a positive electrode, a separator, and a negative electrode are stacked. The positive and negative electrodes are formed by continuously applying active material on a long strip-shaped substrate to form an active material layer and then winding to produce a jelly roll-shaped electrode assembly. In other cases, a stacked electrode assembly may be produced by stacking sheet-type electrodes cut to a certain length.

To increase the capacity of the rechargeable battery, an active material layer is formed on both sides of the substrate. However, the thickness formed on the front and back of the substrate may be different, and there may be a large difference in the thickness at the edges. This difference in the thickness is a difference in the amount of the active material, which may cause performance of the rechargeable battery to degrade. For example, there may be problems such as lithium precipitation during charging and safety problems. Additionally, the differences in the thickness may make the contact state of the electrodes unstable. This may cause performance of the rechargeable battery to degrade, such as with lithium precipitation during charging and safety problems.

### SUMMARY OF THE DISCLOSURE

An embodiment provides a negative electrode for a rechargeable battery, a rechargeable battery, and a method of manufacturing a negative electrode with active material layer uniform thicknesses and a uniform application amounts of the active material layer materials such that there is little difference in the thickness in the active material layers on both surfaces of a substrate.

A negative electrode of a rechargeable battery according to an embodiment includes a substrate, a front active material layer including a first lower layer formed on a first surface of the substrate and a first upper layer formed on the first lower layer, and a rear active material layer including a second lower layer formed on a second surface of the substrate and a second upper layer formed on the second lower layer, wherein an edge of the first lower layer decreases in thickness toward an end of the first lower layer to thereby form a first inclined surface, wherein an edge of the second lower layer decreases in thickness toward an end of the second lower layer to thereby form a second inclined surface, and wherein a thickness of the end of the first lower layer is more than twice a thickness of the end of the second lower layer.

A thickness of the first lower layer at a center of the front active material layer may be less than half of a thickness of the front active material layer, and a thickness of the second lower layer at a center of the rear active material layer may be less than half of a thickness of the rear active material layer.

An angle between the first inclined surface and the first surface of the substrate may be less than an angle between the second inclined surface and the second surface of the substrate.

The first lower layer may be made of a different material than the first upper layer, and the second lower layer may be made of a different material than the second upper layer.

The first lower layer and the second lower layer may be made of the same material, and the first upper layer and the second upper layer may be made of the same material.

The first inclined surface is formed at an edge of the first lower layer and the second inclined surface is formed at an edge of the second lower layer, the edge of the first lower layer may extend up to 15 mm from the end of the first lower layer, and the edge of the second lower layer may extend up to 15 mm from the end of the second lower layer.

The first upper layer may cover the end of the first lower layer, and the second upper layer may cover the end of the second lower layer.

The first lower layer and the second lower layer may be more conductive than the first upper layer and second upper layer.

A rechargeable battery according to another embodiment includes an electrode assembly including the negative electrode describe above, and a separator and a positive electrode stacked with the negative electrode, a case accommodating the electrode assembly and an electrolyte, and a cap assembly sealing the case.

The electrode assembly may be a wound type or a stacked type stacked in the form of a sheet.

A manufacturing method of a negative electrode for a rechargeable battery according to another embodiment includes forming a first lower layer on a front of a substrate, forming a first upper layer on the first lower layer, forming a second lower layer on the rear of the substrate, and forming a second upper layer on the second lower layer.

The first lower layer, the first upper layer, the second lower layer, and the second upper layer may be formed by slot die coating or gravure printing.

The first lower layer may be formed such that an edge of the first lower layer decreases in thickness toward an end of the first lower layer to thereby form a first inclined surface, and the second lower layer may be formed such that an edge of the second lower layer decreases in thickness toward an end of the second lower layer to thereby form a second inclined surface

The first upper layer may be formed to cover the inclined surface of the first lower layer, and the second upper layer may be formed to cover the inclined surface of the second lower layer.

The first lower layer and the second lower layer may be made of a material that is more conductive than a material from which the first upper layer and the second upper layer are made.

A thickness at a center of the first lower layer may be formed to be less than half of a thickness of the front active material layer, and a thickness at a center of the second lower layer may be formed to be less than half of the thickness of the rear active material layer.

In one embodiment, by forming the lower layers and the upper layers alternately on one surface and on the other surface of the substrate, the front active material layer and the rear active material layer consisting of the lower layer and the upper layer may be formed to have a uniform overall thickness. Therefore, phenomena such as lithium precipitation are reduced, thereby providing a stable rechargeable battery.

### BRIEF DESCRIPTION OF THE DRAWINGS

FIG. 1 is a schematic cross-sectional view of an electrode according to an embodiment.

FIG. 2 to FIG. 4 are cross-sectional views to explain a method of manufacturing a negative electrode according to an embodiment.

FIG. 5 is a schematic cross-sectional view of a negative electrode according to another embodiment.

FIG. 6 is a schematic perspective view of a rechargeable battery according to an embodiment.

FIG. 7 is a view taken along a line VI-VI′ in FIG. 6.

FIG. 8 is a schematic top plan view of an electrode assembly according to another embodiment.

FIG. 9 is a cross-sectional view of a portion F of FIG. 8.

FIG. 10 is a schematic top plan view of an electrode assembly according to another embodiment.

### DETAILED DESCRIPTION OF THE EMBODIMENTS

Hereinafter, the present disclosure will be described more fully with reference to the accompanying drawings, in which embodiments of the disclosure are shown. As those skilled in the art would realize, the described embodiments may be modified in various different ways without departing from the spirit or scope of the present disclosure. The drawings and description are to be regarded as illustrative in nature and not restrictive, and like reference numerals designate like elements throughout the specification.

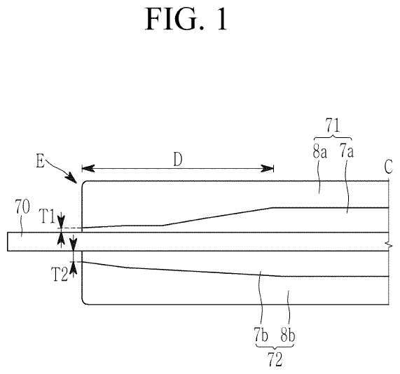

FIG. 1 is a schematic cross-sectional view of an electrode according to an embodiment.

As shown in FIG. 1, an electrode according to an embodiment includes a substrate 70 and an active material layer formed on the substrate 70. The active material layer includes a front active material layer 71 formed on one surface of the substrate 70 and a rear active material layer 72 formed on the other surface.

The front active material layer 71 includes a first lower layer 7a and a first upper layer 8a. The rear active material layer 72 includes a second lower layer 7b and a second upper layer 8b. The first lower layer 7a and the second lower layer 7b are layers formed in contact with the substrate 70. The first upper layer 8a and second upper layer 8b are layers positioned above the first lower layer 7a and the second lower layer 7b, respectively.

The edges of the first lower layer 7a of the front active material layer 71 and the second lower layer 7b of the rear active material layer 72 include surfaces that are inclined relative to the substrate 70. The width D of the edge (i.e., the area where the inclined surfaces are provided) may be up to 15 mm in the direction towards a center C from an end E of the active material layer.

The angle of the inclined surface of the front active material layer 71 is smaller than the angle of the inclined surface of the rear active material layer 72. Thus, the slope of the inclined surface of the rear active material layer 72 may be less than the slope of the inclined surface of the front active material layer 71. Conversely, the angle of the inclined surface of the rear active material layer 72 is greater than the angle of the front inclined surface, so the inclined surface of the rear active material layer may be formed more steeply (not shown).

The thickness T2 of the end of the inclined surface of the rear active material layer 72 may be more than twice the thickness T1 of the end of the inclined surface of the front active material layer 71.

The first upper layer 8a of the front active material layer 71 and the second upper layer 8b of the rear active material layer 72 are formed on the inclined surfaces to compensate for the thickness difference due to the inclination. In other words, as moving from the end E of the edge towards the center C, the thicknesses of the first upper layer 8a and the second upper layer 8b gradually decreases in accordance with the slopes of the inclined surfaces. Accordingly, the thickness of the edges of the front active material layer 71 and the rear active material layer 72 may be constant and may be approximately equal to the thickness at the center C. In other words, the thickness of the active material layer is constant, so the amount of the active material applied at the edge and the center may be about the same.

A negative active material of a negative active material layer that is formed as the front active material layer and the rear active material layer may be a carbon-based active material. The carbon-based negative active material may be artificial graphite or a mixture of artificial graphite and natural graphite.

The use of the crystalline carbon-based material of artificial graphite or the mixture of artificial graphite and natural graphite as the negative electrode active material may further enhance orientation of the carbon material in a plate with respect to an external magnetic field because the material has further developed crystallographic characteristics of particles, as compared with the use of amorphous carbon-based active material. The shape of the artificial graphite or natural graphite may be amorphous, plate-like, flake-like, spherical, fibrous, or any combination thereof. Also, in the case of using the mixture of artificial graphite and natural graphite, a mixture ratio of artificial graphite to natural graphite may be 70:30 wt % to 95:5 wt %.

The negative electrode active material layer may further include at least one of an Si-based negative electrode active material, an Sn-based negative electrode active material, or LiMOx (M=metal)-based negative electrode active material. When the negative electrode active material layer further includes these materials—that is, when the negative electrode active material includes the carbon-based negative electrode active material as a first negative electrode active material and the negative electrode active material as a second negative electrode active material—a mixture ratio of the first negative electrode active material and the second negative electrode active material may be 50:50 wt % to 99:1 wt %.

The LiMOx (M=metal)-based negative electrode active material may be a lithium vanadium oxide.

The Si-based negative electrode active material may be Si, an Si-C complex, SiOx (0<x<2), an Si—Q alloy (where Q is an element selected from the group consisting of an alkaline metal, an alkaline earth metal, group 13 elements, group 14 elements, group 15 elements, group 16 elements, a transition metal, rare earth elements, and a combination thereof, but not Si), the Sn-based negative electrode active material may be Sn, SnO₂, Sn—R alloy (where R is an alkaline metal, an alkaline earth metal, group 13 elements, group 14 elements, group 15 elements, group 16 elements, a transition metal, rare earth elements, and a combination thereof, but not Sn), and the like, or, at least one thereof may be mixed with SiO₂ and used. The elements Q and R may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, and Po and, combinations thereof may be used.

In the negative electrode active material layer, the content of the negative electrode active material may be 95 wt % to 99 wt % with respect to the total weight of the negative electrode active material layer.

The negative electrode active material layer may include a binder and may selectively further include a conductive material. The content of the binder in the negative electrode active material layer may be 1 wt % to 5 wt % with respect to the total weight of the negative electrode active material layer. Also, when the negative electrode active material layer further includes a conductive material, 90 wt % to 98 wt % of the negative electrode active material, 1 wt % to 5 wt % of the binder, and 1 wt % to 5 wt % of the conductive material may be used.

The binder serves to allow the negative electrode active material particles to readily adhere to each other and the negative electrode active material to readily adhere to a current collector. The binder can be a non-soluble binder, a soluble binder, of a combination thereof.

The non-aqueous binder may be polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, polyamide-imide, polyimide, or a combination thereof.

The aqueous binder may be a styrene-butadiene rubber, an acrylated styrene-butadiene rubber (SBR), an acrylonitrile-butadiene rubber, an acrylic rubber, a butyl rubber, polypropylene, an ethylene propylene copolymer, polyepichlorohydrin, polyphosphazene, polyacrylonitrile, polystyrene, an ethylene propylene diene copolymer, polyvinylpyridine, chlorosulfonated polyethylene, latex, polyester resin, an acrylic resin, a phenolic resin, an epoxy resin, polyvinyl alcohol, or a combination thereof.

When the aqueous binder is used as a negative electrode binder, a cellulose-based compound may be further used to provide viscosity as a thickener. The cellulose-based compound includes one or more of carboxymethyl cellulose, hydroxypropyl methylcellulose, methyl cellulose, or alkali metal salts thereof. The alkali metal may be Na, K, or Li. The thickener may be included in an amount of 0.1 parts by weight to 3 parts by weight based on 100 parts by weight of the negative active material.

The conductive material is included to provide electrode conductivity, and any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

A Brunauer-Emmett-Teller (BET) specific surface area of the negative electrode active material layer may be less than 3.0 m²/g and may range from 0.6 m²/g to 1.2 m²/g. When the BET specific surface area of the negative electrode active material layer is less than 3.0 m²/g, electrochemical lifespan characteristics of a cell may be improved.

In an exemplary embodiment of the present disclosure, the BET is measured by charging/discharging the lithium rechargeable battery including the negative electrode, cutting the negative electrode obtained by breaking the battery in a completely discharged state into a predetermined size, and subsequently putting the cut negative electrode into a BET sample holder.

The negative electrode may have a sectional loading level (L/L) of 6 mg/cm² to 65 mg/cm².

The first lower layer 7a and first upper layer 8a, and the second lower layer 7b and the second upper layer 8b may be made of the same material, but the present disclosure is not limited thereto. Rather, the first lower layer 7a and first upper layer 8a may be made of different materials, and the second lower layer 7b and the second upper layer 8b may be made of different materials. The first lower layer 7a and the second lower layer 7b may be materials with relatively greater adherence to the substrate and or greater conductivity than the first upper layer 8a and the second upper layer 8b.

The first lower layer and the second lower layer include carbon-based conductive material. The carbon-based conductive material included in the first lower layer 7a and the second lower layer 7b may be selected from the carbon-based conductive material included in the active material layer. The first lower layer 7a and the second lower layer 7b may include the same carbon-based conductive material as the first upper layer 8a and the second upper layer 8b. For example, since the first lower layer 7a and the second lower layer 7b include a carbon-based conductive material, the first lower layer 7a and the second lower layer 7b may be conductive layers. The first lower layer 7a and the second lower layer 7b may be the conductive layers including, for example, the binder and the carbon-based conductive materials.

If the first lower layer 7a, the second lower layer 7b, the first upper layer 8a, and the second upper layer 8b contain the same carbon conductive material, the conductivity may be varied by varying the carbon material conductive material content of each layer.

The binder included in the first lower layer 7a and the second lower layer 7b may increase the binding force between the substrate and the first upper layer 8a and the second upper layer 8b. The binder included in the first lower layer 7a and the second lower layer 7b may be, for example, a conductive binder or a non-conductive binder. The conductive binder may be, for example, an ion conductive binder, and/or an electron conductive binder. A binder that has both ion conductivity and electron conductivity may belong to both an ion conductive binder and an electron conductive binder.

The ion conductive binder may be, for example, polystyrene sulfonate (PSS), polyvinylidene fluoride-hexafluoropropylene (PVDF-HFP), polyvinylfluoride (PVF), polyvinylidene fluoride (PVDF), polymethyl methacrylate (PMMA), polyethylene oxide (PEO), polyethylene glycol (PEG), polyacrylonitrile (PAN), polytetrafluoroethylene (PTFE), polyethylene deoxy thiophene (PEDOT), polypyrrole (PPy), polyacrylonitrile (PAN), polyaniline, and polyacetylene. The ion conductive binders may include a polar functional group. The ion conductive binder including the polar functional group, for example, may be NAFION™, AQUIVION®, FLEMION™, Gore, ACIPLEX™, MORGANE®-ADP, sulfonated polyether ether ketone (SPEEK), sulfonated poly (arylene ether ether ketone sulfone) (SPAEKKS), polyaryletherketone) (PAEK), poly[bis(benzimidazobenzisoquinolinones)] (SPBIBI), polystyrene sulfonate (PSS), lithium 9,10-diphenylanthracene-2-sulfonate (DPASLi+), etc.

The electron conductive binder, for example, may be polyacetylene, polythiophene, polypyrrole, poly(p-phenylene), poly(phenylenevinylene), polyphenylene sulfide, polyaniline, etc. The middle layer may be a conductive layer including, for example, a conductive polymer.

The binder included in the first lower layer 7a and the second lower layer 7b may be selected from the binders included in the first upper layer 8a and the second upper layer 8b. That is, the first lower layer 7a and the second lower layer 7b may include the same binder as the first upper layer 8a and the second upper layer 8b. The binder included in the first lower layer 7a and the second lower layer 7b may be, for example, a fluorine-based binder. The fluorine-based binder included in the first lower layer 7a and the second lower layer 7b may be, for example, polyvinylidene fluoride (PVDF).

As such, in an embodiment, the lower layers with the inclined surfaces are formed, and the upper layers are formed on the lower layers, thereby providing the edge with a constant thickness. Therefore, a safer rechargeable battery may be provided because phenomena such as lithium precipitation may not occur.

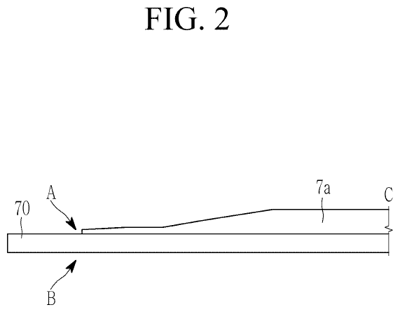

FIG. 2 to FIG. 4 are cross-sectional views to explain a method of manufacturing a negative electrode according to an embodiment.

As shown in FIG. 2, an active material is coated using a coating device on one surface A of a substrate 70, which is continuously supplied through a roll.

Thus, a first lower layer 7a of a front active material layer 71 is formed. The first lower layer 7a may be formed with a thickness of less than half of the thickness of the front active material layer 71 that is to be formed. The first lower layer 71a may be formed using any method that can form layers repeatedly—for example, the first lower layer 7a may be formed by applying a slot die coating or a gravure printing.

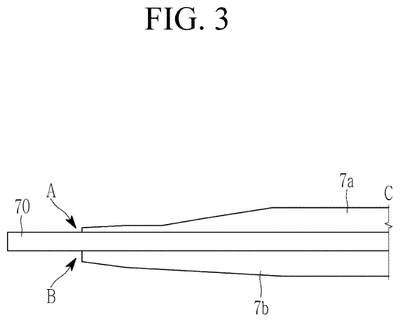

As shown in FIG. 3, after drying the first lower layer 7a, a second lower layer 7b of a rear active material layer 72 is formed on the other surface B of the substrate 70. The lower layer and the upper layer may be formed of different materials—for example, the layers may have different ratios of conductive materials or may include active materials with different specific capacities.

The second lower layer 7b may be formed with a thickness that is less than half of the thickness of the rear active material layer 72 that is to be formed. Also, the end thickness of the second lower layer 7b may be more than twice the end thickness of the front second lower layer 7b.

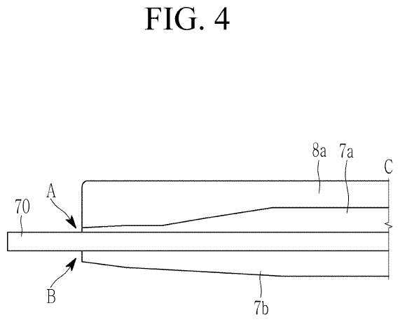

As shown in FIG. 4, after drying the second lower layer 7b, a first upper layer 8a is formed on the first lower layer 7a. The first upper layer 8a is coated onto the entire surface of the first lower layer 7a and may be formed at different thicknesses along the inclined surface of the edge. In other words, the first upper layer 8a may be formed to compensate for the thickness difference in the first lower layer 7a due to the inclined surface. Thus, the front active material layer 71, which consists of the first lower layer 7a and the first upper layer 8a, may be formed with a uniform thickness.

As shown in FIG. 1, a second upper layer 8b is formed on the second lower layer 7b and is then dried. Like the first upper layer 8a, the second upper layer 8b is coated on the entire surface of the second lower layer 7b, and the second upper layer 8b may be formed at different thicknesses along the inclined surface of the edge. In other words, the second upper layer 8b may be formed to compensate for the thickness difference in the second lower layer 7b due to the inclined surface. Thus, the rear active material layer 72, which consists of the second lower layer 7b and the second upper layer 8a, may be formed with a uniform thickness.

As such, in an embodiment, by forming the lower layers and the upper layers alternately on one surface and the other surface of the substrate, the front active material layer and the rear active material layer including of the lower layer and the upper layer may be formed to have uniform thicknesses. Thus, phenomena such as lithium precipitation due to the difference in the thickness of the edge are reduced, thereby providing stability to the rechargeable battery that includes the electrode.

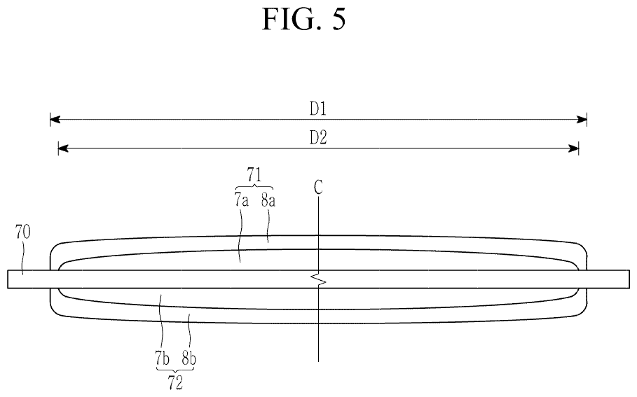

In the above-described embodiment, the lower layer and the upper layer are formed separately, but the present disclosure is not limited thereto. Rather, the lower layer and the upper layer on the front may be formed simultaneously, and the lower layer and upper layer on the rear may be formed simultaneously. Forming the lower layer and the upper layer simultaneously may include not only forming and coating the lower layer and upper layer materials simultaneously, but also sequentially coating the lower layer and upper layer at different coating start times. Further, the ends of the upper layers may be formed to cover the ends of the lower layers. For example, as shown in FIG. 5, the widths D1 of the upper layers may be formed wider than the widths D2 of the lower layers. Even if the upper layers and lower layers are formed simultaneously, the upper layers formed while the lower layers are formed provide for constant thicknesses. Thus, as shown in FIG. 2 to FIG. 4, the thickness of the edge of the active material layer is almost the same as the center.

The above electrode may be used as the negative electrode of the rechargeable battery and is explained below with reference to the accompanying drawings.

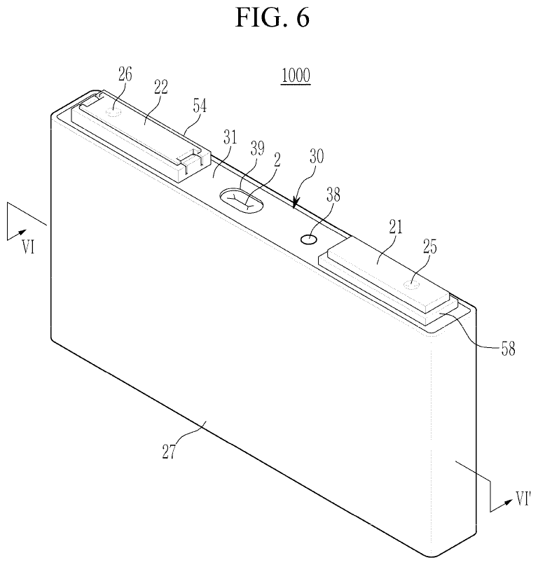

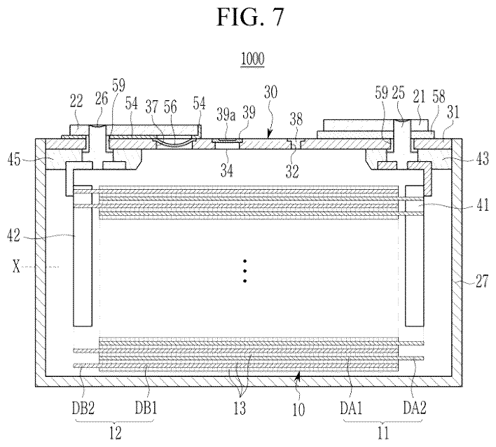

FIG. 6 is a schematic perspective view of a rechargeable battery according to an embodiment. FIG. 7 is a view taken along a line VI-VI′ of FIG. 6.

As shown in FIG. 6 and FIG. 7, a rechargeable battery 1000 according to an embodiment includes an electrode assembly 10, a case 27 accommodating the electrode assembly 10, and a cap assembly 30 installed in the opening of the case 27.

The electrode assembly 10 includes sequentially stacked positive electrodes 11 and negative electrodes 12, and a separator 13 positioned between the electrodes. That is, the separator 13 is placed between the positive electrode 11 and the negative electrode 12 and insulates the electrodes from each other. The electrode assembly 10 may be a jelly roll type that is wound around a winding axis X with the separator 13 interposed between the positive electrode (or the first electrode) 11 and the negative electrode (or the second electrode) 12 and then pressed flat.

The positive electrode 11 includes a substrate, a first electrode coated region DA1 formed by an active material layer on the substrate, and a first electrode uncoated region DA2 where the substrate is exposed by not applying an active material. The substrate of the positive electrode may be aluminum, and as the positive electrode active material forming the active material layer of the positive electrode 11, a compound (lithiated intercalation compound) capable of reversibly intercalating and deintercalating lithium ions may be used. Specifically, one or more composite oxides of a metal selected from cobalt, manganese, nickel, and a combination thereof, and lithium may be used. The content of the positive active material may be 90 wt % to 98 wt % with respect to the entire weight of the positive active material layer.

The positive active material layer may further include a binder and a conductive material. The content of the binder and the conductive material may be 1 wt % to 5 wt %, respectively, with respect to the entire weight of the positive active material layer. The binder serves to adhere the positive active material particles to each other and also to adhere the positive active material to the substrate, which is the current collector. Representative examples of the binder include polyvinyl alcohol, carboxymethylcellulose, hydroxypropyl cellulose, diacetyl cellulose, polyvinyl chloride, carboxylated polyvinyl chloride, polyvinyl fluoride, polymer including ethylene oxide, polyvinylpyrrolidone, polyurethane, polytetrafluoroethylene, polyvinylidene fluoride, polyethylene, polypropylene, styrene-butadiene rubber, acryl federated styrene-butadiene rubber, epoxy resin, and nylon, but it is not limited thereto. The conductive material is used to provide conductivity to the electrode, and in the configured battery, any material may be used as an electron conductive material as long as it does not cause a chemical change.

The negative electrode as the negative electrode shown in FIG. 1 includes a second electrode coated region DB1 in which an active material layer is formed on the substrate and a second electrode uncoated region DB2 in which the substrate is exposed by not coating the active material. As described above, the active material layer of the negative electrode consists of a front active material layer including a first lower layer and a first upper layer, and a rear active material layer including a second lower layer and a second upper layer formed on the other surface of the substrate. The front active material layer and the rear active material layer may have the same specific capacity and thickness at the central portion and the edge.

As also described above, the edges of the lower layer of the front active material layer of the negative electrode and the lower layer of the rear active material layer may include inclined surfaces, the angle of the inclined surface of the front active material layer may be less than the angle of the inclined surface of the rear active material layer, so the slope may be formed more gently than the inclined surface of the rear active material layer. The thicknesses of the edges of the first lower layer and the second lower layer decreases toward the ends to form a first inclined surface and a second inclined surface, respectively, and the end thickness of the first lower layer may be more than twice the end thickness of the second lower layer.

The edge of the negative active material layer may be any place where the end of the negative active material layer is positioned—for example, it may be a region adjacent to the second electrode uncoated region DB2.

In an embodiment, by forming the lower layer with the inclined surface on the negative electrode and forming the upper layer on the lower layer, the thickness of the edge is constant, thereby reducing phenomena such as lithium precipitation. In other words, since the coated amount of the active material applied becomes almost the same at the edge and the central portion, there is little or no difference in the specific capacity between the edge and the central portion. Therefore, the resulting lithium precipitation phenomenon is minimized and safety may be improved.

The separator 13 may include, for example, polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The electrode assembly 10 may be accommodated in the case 27 together with the electrolyte, and the electrolyte may include a non-aqueous organic solvent and a lithium salt. The non-aqueous organic solvent serves as a medium through which ions involved in the electrochemical reaction of the battery can move. The lithium salt is dissolved in an organic solvent and acts as a supply source of lithium ion in the battery, enabling basic lithium secondary battery operation, and is a material that promotes the movement of lithium ions between the positive and negative electrodes. Representative examples of such lithium salts include one, two, or more selected from the group consisting of LiPF₆, LiBF₄, LiSbF₆, LiAsF₆, LiN (SO₂C₂F₅)₂, Li (CF₃SO₂)₂N, LiN (SO₃C₂F₅)₂, LiC₄F₉SO₃, LiClO₄, LiAlO₂, LiAlCl₄, LiN (CₓF₂ₓ₊₁SO₂, C_{y}F_{2y+1}SO₂, x and y are natural numbers, such as an integer of 1 to 20), LiCl, LiI and LiB C₂O₄₂ (lithium bis(oxalato) borate: LiBOB) as a supporting electrolytic salt. I A lithium salt concentration within the range of 0.1 M to 2.0 M may be used. When the concentration of lithium salt is in this range, the electrolyte has appropriate conductivity and viscosity, so it can exhibit excellent electrolyte performance, and lithium ions can move effectively.

The case 27 may be made of a metal such as aluminum and may be a roughly rectangular parallelepiped. One side of the case 27 may be opened, and a cap plate 31 may be installed on the open side of the case 27.

The cap assembly 30 includes the cap plate 31 coupled to the case 27 and blocking the opening of the case 27, a positive terminal 21 protruded outside the cap plate 31 and electrically connected to the positive electrode 11, and a negative terminal 22 electrically connected to the negative electrode 12. The cap plate 31 is in the form of an elongated plate connected in one direction and is coupled to the opening of the case 27. The cap plate 31 includes an injection port 32 that extends to inside of the case 27. The injection hole 32, which is used to inject the electrolyte solution, includes a sealing stopper 38. In addition, a vent plate 39 with a notch 39a is installed in the vent hole 34 so that the cap plate 31 may be opened at a predetermined pressure.

The positive terminal 21 and negative terminal 22 are installed to protrude from the cap plate 31. The positive terminal 21 is electrically connected to the positive electrode 11 through a current collecting tab 41, and the negative terminal 22 is electrically connected to the negative electrode 12 through a current collecting tab 42.

A terminal connection member 25 is installed between the positive terminal 21 and the current collecting tab 41 to electrically connect the positive terminal 21 and the current collecting tab 41. The terminal connection member 25 is inserted into the hole formed in the positive terminal 21, and the upper end is affixed to the positive terminal 21 by welding. The lower end of the terminal connection member 25 is affixed to the current collecting tab 41 by welding.

A gasket 59 for sealing is installed between the terminal connection member 25 and the cap plate 31 by being inserted into the hole through which the terminal connection member 25 passes. A lower insulating member 43, into which the lower part of the terminal connection member 25 is inserted, is installed below the cap plate 31. A connection plate 58 is installed between the positive terminal 21 and the cap plate 31 to electrically connect them. The terminal connection member 25 is installed by being inserted into the connection plate 58. Accordingly, the cap plate 31 and the case 27 are charged with the positive electrode 11.

A terminal connection member 26 that electrically connects the negative terminal 22 and the current collecting tab 42 is installed between the negative terminal 22 and the current collecting tab 42. The terminal connection member 26 is inserted into the hole formed in the negative terminal 22. The upper end of the terminal connection member 26 is affixed to the negative terminal 22 by welding, and the lower end of the terminal connection member 26 is affixed to the current collecting tab 42 by welding.

Between the negative terminal 22 and the cap plate 31, a gasket 59 for sealing is installed by being inserted into the hole through which the terminal connection member 26 passes, and an upper insulating member 54 that insulates between the negative terminal 22 and the cap plate 31 is installed. The terminal connection member 26 may be installed by being inserted into the hole of the upper insulating member 54, and the upper insulating member 54 may be formed to surround the end of the negative terminal 22. Below the cap plate 31, a lower insulating member 45 is installed to insulate the negative terminal 22 and the current collecting tab 42 from the cap plate 31.

A short-circuit hole 37 is provided in the cap plate 31, and the short-circuit member 56 is provided in the short-circuit hole 37. The short-circuit member 56 includes a curved portion to be curved downward in a convex manner and an edge portion provided outside the curved portion and affixed to the cap plate 31. The upper insulating member 54 may include an incised portion overlapping the short-circuit hole 37 such that the short-circuit member 56 overlaps the negative terminal 22 exposed through the incised portion.

The short-circuit member 56 is electrically connected to the cap plate 31 and is transformed when an internal pressure of the rechargeable battery 1000 is increased, thereby causing a short circuit of the positive electrode and the negative electrode. That is, when gas is generated inside the rechargeable battery because of an abnormal reaction, the internal pressure of the rechargeable battery increases. And when the internal pressure of the rechargeable battery becomes greater than a predetermined pressure, the curved portion of the short-circuit member 56 is transformed to be convex upward, and the negative terminal 22 touches the short-circuit member 56 to cause a short circuit. To ease the short circuit of the negative terminal 22 and the short-circuit member 56, the negative terminal 22 may further include at least at least one protrusion (not shown) protruding toward the short-circuit member 56, and the protrusion may be separated from the short-circuit member 56.

In the above described embodiment, the electrode assembly is in the form of a wound-type structure, but the present disclosure is not limited thereto. Rather, an electrode assembly having a sheet-type stacking structure may be used. In addition, although the rechargeable battery including a prismatic case has been described, a battery according to the present disclosure is not limited thereto and it may include a cylindrical case and a pouch-type case.

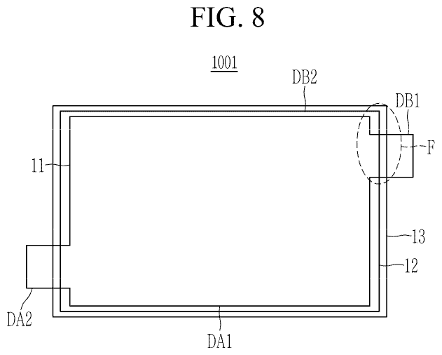

FIG. 8 is a schematic top plan view of an electrode assembly according to another embodiment.

As shown in FIG. 8, an electrode assembly 1001 according to another embodiment includes a positive electrode 11, a negative electrode 12, and a separator 13. In this electrode assembly 1001, the positive electrode 11 and the negative electrode 12 are positioned on opposite sides with the separator 13 in between. The positive electrode 11, negative electrode 12, and separator 13 are alternately stacked. in particular, the positive electrode 11, the negative electrode 12, and the separator 13 may each have a form of a separated sheet and may be stacked in plural numbers.

The positive electrode 11 includes a first electrode coated region DA1 where an active material layer is formed on the substrate and a first electrode uncoated region DA2 where the substrate is exposed by not applying the active material. The negative electrode 12 includes a second electrode coated region DB2 in which an active material layer is formed on the substrate and a second electrode uncoated region DB1 in which the substrate is exposed by not applying the active material. The first electrode uncoated region DA2 and the second electrode uncoated region DB1 may protrude from the separator 13, and the same polarities may be connected by welding.

The negative electrode 12 is the negative electrode shown in FIG. 1. That is, the active material layer of the negative electrode includes a front active material layer including a first lower layer 8a and a first upper layer 7a, and a rear active material layer including a second lower layer 7b and a second upper layer 8b formed on the other surface of the substrate 70.

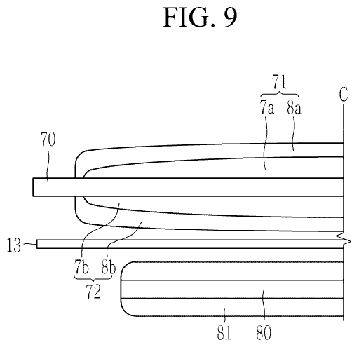

FIG. 9 is a cross-sectional view of a part F of FIG. 8.

Referring to FIG. 9, the edges of the first lower layer 7a of the front active material layer of the negative electrode and the second lower layer 7b of the rear active material layer may include a surface that is inclined relative to the substrate 70, and the angle of the inclined surface of the front active material layer may be smaller than the angle of the inclined surface of the rear active material layer such that the slope may be formed more gently than the inclined surface of the rear active material layer.

The thickness of the edges of the first lower layer 7a and the second lower layer 7b decreases toward the end of the electrode, thereby forming a first inclined surface and a second inclined surface, respectively. The end thickness of the first lower layer 7a may be more than twice the end thickness of the second lower layer 7b.

The edge of the negative active material layer may be any place where the end of the negative active material layer is positioned. For example, the edge may be a region adjacent to the second electrode uncoated region DB1.

As in this embodiment, the thickness difference between the edge and the central portion may be reduced by increasing the thickness of the edge by forming the edge of the negative active material layer with the lower layer and the upper layer formed on the lower layer. Therefore, when overlapping with the positive electrode that is smaller in size than the negative electrode, the edge of the positive electrode overlaps the edge of the negative electrode with the uniform thickness, so lithium precipitation due to thickness deviation does not occur.

FIG. 7 and FIG. 8 illustrate, but are not limited to, the first electrode uncoated region DA2 and the second electrode uncoated region DB1 protruding in different directions. As shown in FIG. 8, the first electrode uncoated region DA2 and the second electrode uncoated region DB2 of the electrode assembly 1002 may be protruded in opposite directions.

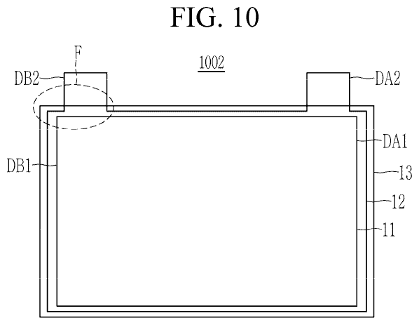

FIG. 10 is a schematic top plan view of an electrode assembly according to another embodiment.

The electrode assembly 1002 of FIG. 10 may be the wound electrode assembly as shown in FIG. 7. But, unlike in FIG. 7, the electrode uncoated regions DA2 and DB2 may be repeatedly formed by protruding from the electrode coated regions DA1 and DB1 at regular intervals. The electrode uncoated regions DA2 and DB2 of the same polarity may be connected by welding. In part F adjacent to the second electrode uncoated region DB2, where the end of the negative active material layer is positioned, as shown in FIG. 9 the lower layer and the upper layer are formed so that the thickness of the edge may be almost the same as that of the central portion.

While this disclosure has been described in connection with what is presently considered to be practical exemplary embodiments, it is to be understood that the disclosure is not limited to the disclosed embodiments. On the contrary, is intended to cover various modifications and equivalent arrangements included within the spirit and scope of the appended claims.

What is claimed is:

1. A negative electrode for a rechargeable battery comprising:
a substrate,
a front active material layer including a first lower layer formed on a first surface of the substrate and a first upper layer formed on the first lower layer, and
a rear active material layer including a second lower layer formed on a second surface of the substrate and a second upper layer formed on the second lower layer,
wherein an edge of the first lower layer decreases in thickness toward an ends of the first lower layer to thereby form a first inclined surface,
wherein an edge of the second lower layer decreases in thickness toward an end of the second lower layer to thereby form a second inclined surface, and
wherein a thickness of the end of the first lower layer is more than twice a thickness of the end of the second lower layer.

2. The negative electrode for the rechargeable battery of claim 1, wherein a thickness of the first lower layer at a center of the front active material layer is less than half of a thickness of the front active material layer, and
wherein a thickness of the second lower layer at a center of the rear active material layer is less than half of a thickness of the rear active material layer.

3. The negative electrode for the rechargeable battery of claim 1, wherein an angle between the first inclined surface and the first surface of the substrate is less than an angle between the second inclined surface and the second surface of the substrate.

4. The negative electrode for the rechargeable battery of claim 1, wherein the first lower layer is made of a different material than the first upper layer, and
wherein the second lower layer is made of a different material than the second upper layer.

5. The negative electrode for the rechargeable battery of claim 1, wherein the first lower layer and the second lower layer are made of the same material, and
wherein the first upper layer and the second upper layer are made of the same material.

6. The negative electrode for the rechargeable battery of claim 1, wherein:
the first inclined surface is formed at an edge of the first lower layer and the second inclined surface is formed at an edge of the second lower layer, and
wherein the edge of the first lower layer extends up to 15 mm from the end of the first lower layer, and
wherein the edge of the second lower layer extends up to 15 mm from the end of the second lower layer.

7. The negative electrode for the rechargeable battery of claim 1, wherein the first upper layer covers the end of the first lower layer, and the second upper layer covers the end of the second lower layer.

8. The negative electrode for the rechargeable battery of claim 1, wherein the first lower layer and the second lower layer are more conductive than the first upper layer and second upper layer.

9. A rechargeable battery comprising:
an electrode assembly including a negative electrode of claim 1, and a separator and a positive electrode stacked with the negative electrode,
a case accommodating the electrode assembly and an electrolyte, and
a cap assembly sealing the case.

10. The rechargeable battery of claim 9, wherein the electrode assembly is a wound type.

11. The rechargeable battery of claim 9, wherein the electrode assembly is stacked in sheet form.

12. A manufacturing method of a negative electrode for a rechargeable battery comprising:
forming a first lower layer on a front of a substrate,
forming a first upper layer on the first lower layer,
forming a second lower layer on the rear of the substrate, and
forming a second upper layer on the second lower layer.

13. The manufacturing method of a negative electrode for a rechargeable battery of claim 12, wherein the first lower layer, the first upper layer, the second lower layer, and the second upper layer are formed by a slot die coating or a gravure printing.

14. The manufacturing method of a negative electrode of a rechargeable battery of claim 12, wherein the first lower layer is formed such that an edge of the first lower layer decreases in thickness toward an end of the first lower layer to thereby form a first inclined surface, and
wherein the second lower layer is formed such that an edge of the second lower layer decreases in thickness toward an end of the second lower layer to thereby form a second inclined surface.

15. The manufacturing method of a negative electrode for a rechargeable battery of claim 14, wherein the first upper layer is formed to cover the inclined surface of the first lower layer, and
wherein in the forming of the second upper layer, the second upper layer is formed to cover the inclined surface of the second lower layer.

16. The manufacturing method of a negative electrode for a rechargeable battery of claim 12, wherein the first lower layer and the second lower layer are made of a material that is more conductive than a material from which the first upper layer and the second upper layer are made.

17. The manufacturing method of the negative electrode for the rechargeable battery of claim 12, wherein a thickness at a center of the first lower layer is formed to be less than half of a thickness of the front active material layer, and
wherein a thickness at a center of the second lower layer is formed to be less than half of a thickness of the rear active material layer.
